(19) United States
(12) Patent Application Publication
(10) Pub. No.: US 2013/0041831 A1
(43) Pub. Date: Feb. 14, 2013

(54) SECURE AND SHAREABLE PAYMENT SYSTEM USING TRUSTED PERSONAL DEVICE

(71) Applicant: Pranamesh Das, Noida (IN)

(72) Inventor: Pranamesh Das, Noida (IN)

(21) Appl. No.: 13/640,871

(22) PCT Filed: Apr. 13, 2011
(86) PCT No.: PCT/IN2011/000252

§ 371 Date: Oct. 12, 2012

(30) Foreign Application Priority Data
Apr. 13, 2010 (IN) 893/DEL/2010

(51) Int. Cl. G06Q 20/00

(52) U.S. Cl. 705/72; 705/64

(57) ABSTRACT

The invention relates to a system and method of making a financial transaction using a Trusted Personal Device. More particularly, the invention relates to a highly secure and less cumbersome payment platform for making a financial transaction using a trusted personal device, that too without any requirement of any formal means of communication between the customer and the merchant. The system and method is devised to obviate the problems of frauds relating to electronic cards like credit card, debit card, recharge cards, loyalty cards, other chip based cards, traveller's cheques etc.

### FIELD OF THE INVENTION

The invention relates to a system and method of making a financial transaction using a Trusted Personal Device. More particularly, the invention relates to a highly secure and less cumbersome payment platform for making a financial transaction using a trusted personal device, that too with or without any requirement of any formal means of communication between the customer and the merchant or between the customer and the financial institutions (e.g. card issuer and banks) at the point of transaction. The system and method is devised to obviate the problems of frauds relating to electronic cards like credit card, debit card, recharge cards, loyalty cards, other chip based cards, traveller's cheques etc. The system and method is devised also to address certain usability shortcomings of using chip based secure NFC transactions.

### BACKGROUND OF THE INVENTION

The use and advancement of the technologies relating to the methods of financial transactions have observed many milestones. Lately, with the development of the Information Technology and electronic era, electronic card transactions have become one of the most versatile payment methods for exchange of goods and services.

Currently, there are very common and preferred means of payment by consumers leading to significant increase in their use ever since the method of electronic payment was invented. With the increase in demand of e-payment enabling systems increased the variety of such products.

There are various types of cards namely, but not limited to, credit cards, debit cards, charge cards, coupons and incentive cards, recharge cards, loyalty cards, chip based cards and traveller's cheques.

Since they are used widely, they have been the favorites of criminals and thus are highly prone to thefts which amount to billions of dollars of losses to the card issuers worldwide every year. Ever since there has been an ongoing effort to increase the security of such payment processes so that the card theft and frauds are minimized or removed however, most of such efforts have been at the cost of convenience of the user using the cards.

The card processing industries have been working on PIN based cards, Chip based cards, CVV (Card verification Value) based security and other means of securitize the card while maintaining the simplicity of using the plastic card. Inspite, most of these methods have some or the other vulnerabilities and despite all claims, the industry still continues to incur heavy losses which proves that these methods have not been able to tackle the problem effectively. This has become all the more acute with the ever increasing online payment with the advent of e-commerce.

Some of the means of theft of card data are as follows
While a Point of Sale (POS) transaction is done, typically the consumer hands over the card to the merchant to do the transaction. Such a scenario provides ample opportunities to the merchant or the merchant's employees with bad intentions to simply copy the card data by reading the magnetic data and duplicating it later for making fraudulent transactions.
Cards with PIN are meant to be secure, but since the PIN pad at a merchant's POS terminal is another device owned by the merchant, the PIN is vulnerable to copy and later misuse.
PIN numbers can be very easily recorded using video camera's placed at strategic locations or more commonly using the mobile phone camera which has become so ubiquitous these days.
Cards, when lost, are most vulnerable as they can be used by virtually any one.
Cards used on online sites are vulnerable to multitude of hacking such as phishing, eavesdropping, keystroke monitors etc.
Even smart cards which were known to be very secure have been recently shown to be prone to an very effective attack known as “Man-in-Middle Attack”

Apart from the theft issues there are other problems with the card based payments as follows
The POS terminals are very expensive which has prevented smaller business to acquire them and process such payments.
Many a times, POS terminals are not interbank compatible, often using multiple POS terminals at same merchant's place. This adds to much more costs of using the system.
POS terminals are inherently bulky which has prevented a large segment of business from adopting them which are conducted on the move, like fast-food delivery, courier delivery, road side vendors without geographically fixed shops etc.
Many people increasingly have multiple cards, and carrying many of them in the single purse becomes inconvenient many at times.

Off late the mobile phones have been seen as a medium of providing a competing payment means compared to the card based payment, so much so that there is a flurry of products and systems that have started to offer products and services to this effect. Such products are in preliminary testing stages and are currently gauging the acceptance of the consumers for using mobile phones for conducting financial transactions. While it has been found that there is a general wiliness of people being able to use the mobile phone, there exists equally challenging problems that needs addressing.

Some of the challenges of the mobile phone based systems are as follows
Almost all of such mobile phone based payment systems are dependent on some form of connectivity to the network either in the form of, but not limited to, GPRS, SMS, Bluetooth, and WIFI from the consumer's (sender) device to do the transaction. Such connectivity requirement reduces the versatility of the system as, many a times, such connectivity may not be possible for example, the consumer may be out of coverage area of his or her mobile service provider's range, like in basements or if the consumer is out of city or country without roaming facilities, or simply because the said service provider doesn't operate in the area of interest of the consumer. Connectivity is also a big problem in mobile networks when there is very high loads on the network on specific days like New Year's Eve, or other festive times etc., when there are high call drops and SMSs never reach in time, all the while such times may be very important as a high volume of consumer goods related commercial transactions happen during such times.
Almost all of such systems have elaborate registration processes that defeats the purpose of simplicity of conducting a transaction by as simple as handing over the card to the merchant.
Almost all of such systems require the consumer to send card details across to the processing server for storage and later authentication and processing at the time of a transaction. This is inherently unsafe, as we have heard many a times of such card details being stolen in bulk from the storage servers which puts tens of thousands and sometimes millions of card accounts at stake.
Almost all of such solutions provided that uses the Near Field Communication (NFC) infrastructure require mobile devices that are NFC compliant, either using inbuilt features or by use of NFC peripheral cards like SD Card or specialized SIM cards with NFC. All of such solutions are therefore expensive to adopt, restrictive in use and does not provide universal compatibility to the payment system.
Almost all such systems put the burden of selection of the merchant to the consumer even if the consumer is at the premises of the merchant. This makes the solution have a very cumbersome merchant (receiver) selection procedures which severely limits the wide utility of such payment systems. This in turn indirectly affects the acceptability of such systems.
Almost all systems have elaborate security schemes to achieve security levels acceptable to the industry to combat theft, but this again increases the system's complexity, thereby its utility and limited reach.
Because the existing systems requires some or other medium of communication from the consumer (sender), there are always some reliability issues, which inherently forces the regulatory authorities to limit the maximum payments allowed on a single day, so that if any loss occurs, then such losses are limited in liability. This seriously affects the systems wide spread acceptability and there are multitudes of business which cross such limits.
Many of such systems have proposed severe changes in the infrastructure of the payment processing industry's current system that implementing such new systems adds billions of dollars of investments which again has become major bottle necks.
Even if we consider the fact that chip card based or Near Field Communication (NFC) based transactions will be more secure, it still requires the trust of the merchant to be an active part of the secure ecosystem deliver the claimed security enhancements.

### OBJECT OF THE INVENTION

The principal object of this invention is to provide a secure payment system using trusted personal device.

Another object of this invention is to provide highly secure and less cumbersome payment transaction system.

A further object of this invention is to provide a payment transaction without the need of a formal communication system.

A further object of this invention is to obviate the limitation of mobile phone uses during the payment transaction and expand the services through Trusted Personal Devices (TPD) which could be the Mobile Phone, MP3 Player like iPod, PDA, Smartphone etc.

A further object of this invention is to prevent the copy or theft of card or bank account information from the Point of Sale (POS).

A further object of this invention is to transfer the user card information in an encrypted data in the form of picture, video, audio, wired or RF communication like NFC to the merchant processing machine to complete the transaction.

A further object of this invention is to minimize the ost and complexity of the transaction devices at the Point of Sale (POS) terminus.

A further object of this invention is to free the user to carry single or multiple transaction cards viz. credit cards, debit cards, charge cards, coupons and incentive cards, recharge cards, loyalty cards, chip based cards etc. while shopping at the POS terminus.

A further object of this invention is to prevent the sharing of card data to the central processing server or any number of other transaction devices between the users's TPD and the user's bank or card issuer for a transaction processing.

A further object of this invention is to provide a secure transaction of payment between the users without requirement of POS terminus.

A further object of this invention is to separate the PIN pad, card information, swiper or scanner and the merchant POS terminal.

A further object of this invention is to provide a robust irrefutable trusted transaction verification means for the user.

A further object of this invention is to provide a means of managing multiple payment options at POS terminal that are not limited to card usage only.

A further object of this invention is to provide a parental control on card expenses in a extensively configurable way.

A further object of this invention is to provide multiple add on card accessibility to the main account holder without any limitation or requirement of the card issuer.

A further object of this invention is to provide accessibility to card usage at multiple geographically separate places simultaneously for a single card or bank account.

A further object of this invention is to allow the user to know of loyalty benefits basis at the point of sale.

A further object of this invention is to manage the expenses of the user by giving alerts and advices on card accounts about the credit and interest fees applicable at the POS terminal.

A further object of this invention is to provide emergency expenses by controlling a fixed predetermined reserve credit limit on the cards on frequent use.

A further object of this invention is to enable sharing of card processing merchant accounts to get benefits of lower transaction charges.

A further object of this invention is to enable the user to block all cards and accounts simultaneously in case of theft or loss of TPD without the need of remembering any of the card or account details at the point of loss.

A further object of this invention is to enable the user to schedule payments of regular bills at predetermined intervals.

A further object of this invention is to emulate the paper transaction slips thereby reducing the usage of paper slips and help the environment

A further object of this invention is to allow the provision of affixing photo or picture of the user for a transaction to make it more secure at the POS terminal.

A further object of this invention is to allow the provision of fixing GPS data of the point of transaction if it is available from the TPD or the merchant device.

### SUMMARY OF THE INVENTION

The invention relates to a system and method of making a financial transaction using a Trusted Personal Device. More particularly, the invention relates to a highly secure and less cumbersome payment platform for making a financial transaction using a trusted personal device, that too without any requirement of any formal means of communication between the customer and the merchant.

In a preferred embodiment of the invention, the purpose is to separate the user's secure ecosystem to any other provided by any other system be it NFC or otherwise, so that the user can truly trust the system and process transactions with higher confidence even in situations where a formal communication with the user's account may not be verifiable at the point of transaction through the normal means of communications like OTA (Over The Air) in NFC ecosystem.

In a preferred embodiment of the invention, the purpose is to maintain the simplicity of a card based transaction for the consumer (sender) and the merchant (receiver) and provide the service using mobile so that multiple cards or accounts are no longer needed. Further, it is aimed at making almost all the transaction process offline which implying that there is no need of any communication network availability from the consumer's side at the time of making a payment. Communication is required only for the merchants who are small in number (compared to number consumers) and they already have some form of communication to continue to do their current business.

In another embodiment of the invention proposes very easy integration of such system with existing payment infrastructure is described wherein virtually no major infrastructural change is required in the present card processing system or network. It is aimed at providing superior security for the transaction so that no one except the card issuer's transaction server knows about the card details. Merchants can process transaction on their TPD or mobile phones so that small business as well as business with high mobility finds it very easy and useful to adopt.

In yet another embodiment, the transaction instruments can be sharable so that family members who are not eligible for cards etc., can “electronically borrow” the cards from guardians.

The invention accordingly comprises several steps and relation of one or more of such steps with respect to each of the others, and the various features and steps, all is exemplified in the following detailed disclosure, and the scope of the invention is indicated in the claims.

### BRIEF DESCRIPTION OF THE DRAWINGS

For a complete understanding of this invention, references are made to the following description taken in connection with the accompanying drawings, in which:

FIG. 1 is a type of Trusted Personal Device (TPD).

FIG. 2 is a downloadable feature of E-pay software.

FIG. 3 is a key generation dialog box.

FIG. 4 is a registration dialog box.

FIG. 5 is a card detail dialog box.

FIG. 6 is a user log in dialog box.

FIG. 7 is a user selection dialog box.

FIG. 8 is a user code generation dialog box.

FIG. 9 is a user code transfer mode.

FIG. 10 is a server communication system.

FIG. 11 is a server verification dialog box.

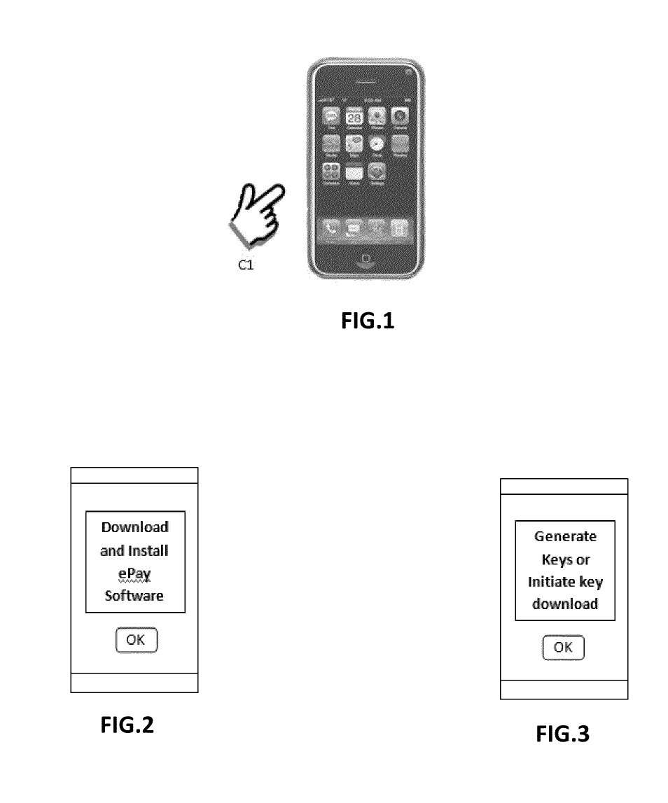

### DETAILED DESCRIPTION OF THE INVENTION

The invention relates to a system and method of making a financial transaction using a Trusted Personal Device. More particularly, the invention relates to a highly secure and less cumbersome payment platform for making a financial transaction using a trusted personal device, that too without any requirement of any formal means of communication between the customer and the point of sale.

To initiate the transaction, a consumer C1 (user) needs a trusted personal device (TPD) which may be an electronic device that belongs to the user which holds personal data of such user in electronic form and that he or she uses in their daily activities of life. For example, but not limited to, a trusted device could be the mobile phone, mp3 player like the iPod, PDA, smartphone etc. The consumer installs a small application on his TPD to utilize this innovative payment platform. For example, but not limited to, if the TPD is the mobile phone, it could be an j2ME application that can be installed on the mobile phone and this will enable the consumer to process and make payments for goods and services provided by merchants who are connected to the backend system of this invention. In another system if the TPD is a phone, the application could even lie in the SIM Card of the phone. However, the exact placement of the application is immaterial so long it is accessible from the TPD's user and the user is able to execute it without ambiguity. The uniqueness of the proposed invention takes care of the security irrespective of the placement of the application.

The installation of the consumer's application happens over a multitude of mediums depending on what kind of TPD is being used. For example, but not limited to, for a mobile phone TPD, the user sends an SMS with the relevant product code requesting for the application upon which the SMS server sends him the link to downloading the application on the phone using GPRS or any other convenient network dependent methods. In another embodiment, if the TPD is an iPod Touch, then the user can initiate a simple registration on the authoritative website and he will able to download the application and install in his TPD. To maintain a high level of security, each the application to be downloaded contains specialized identification codes depending on some hardware ID of the TPD like that of, but not limited to, IMEI number of mobile phone, Bluetooth ID of device, Network MAC ID, HDD ID etc.

The application also contains individualized encryption keys for securing all communication between the consumer application and the authorization server. This is important, because in the eventuality of a breach of a particular TPD, the system's security is not compromised as the keys of other users of the system remains different. Alternatively, if any financial institution requires the loading of their own specific keys for added security, then that can also be done seamlessly by any means, including OTA (Over the air) applications.

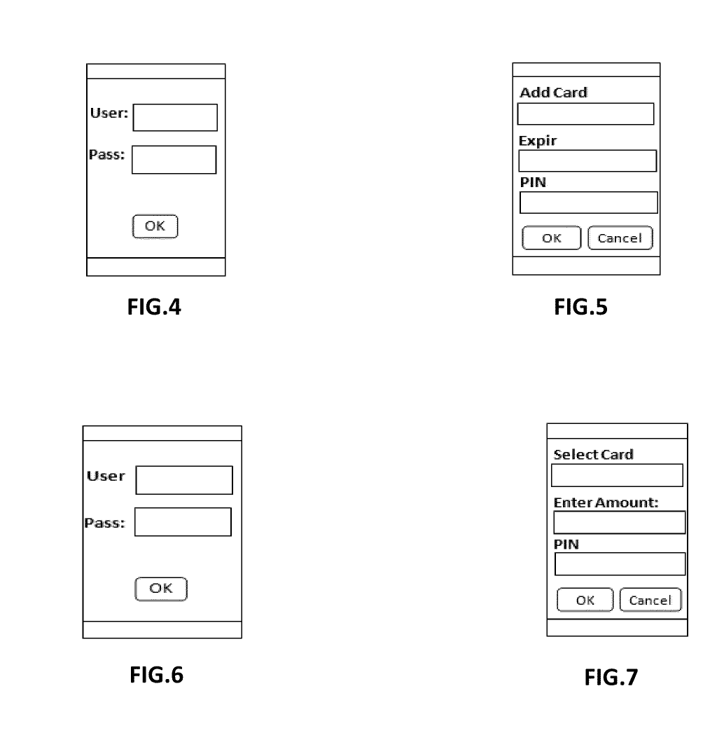

After the user installs the application, on the first run of the application the user will be required to set up all the passwords of their choice for securitization of access to the application residing on the TPD. Thereafter the user can add multitude of payment instruments like, but limited to, credit cards, debit cards, charge cards and internet banking accounts into the consumer application. This is shown in FIG. 4 and FIG. 5.

For the merchant to accept payments either for an over-the-counter sale (or a sale on the internet using an embodiment of the invention), he needs an electronic device capable of connecting to the payment servers over the network. The network connectivity could happen over a multitude of possibilities, depending on the capability of the device. For example, but not limited to, if the merchant device is a mobile phone, then he can communicate with the authorization sever using GPRS, EDGE, 3G, Wi-Fi (if there is an Wi-Fi capability on the phone) including slower mediums like SMS. In another case, the merchant device could be an iPod Touch, with a Wi-Fi connectivity capability.

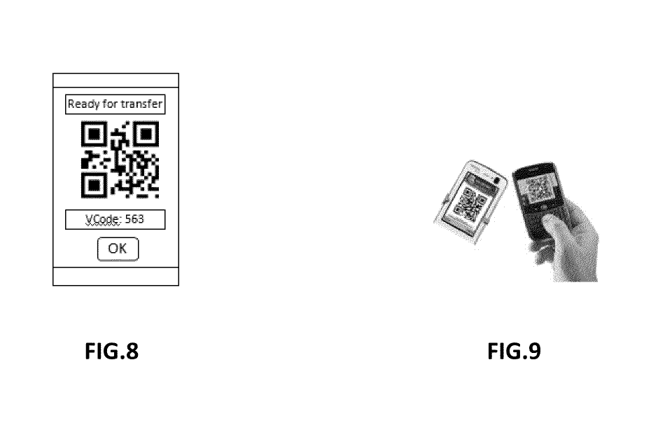

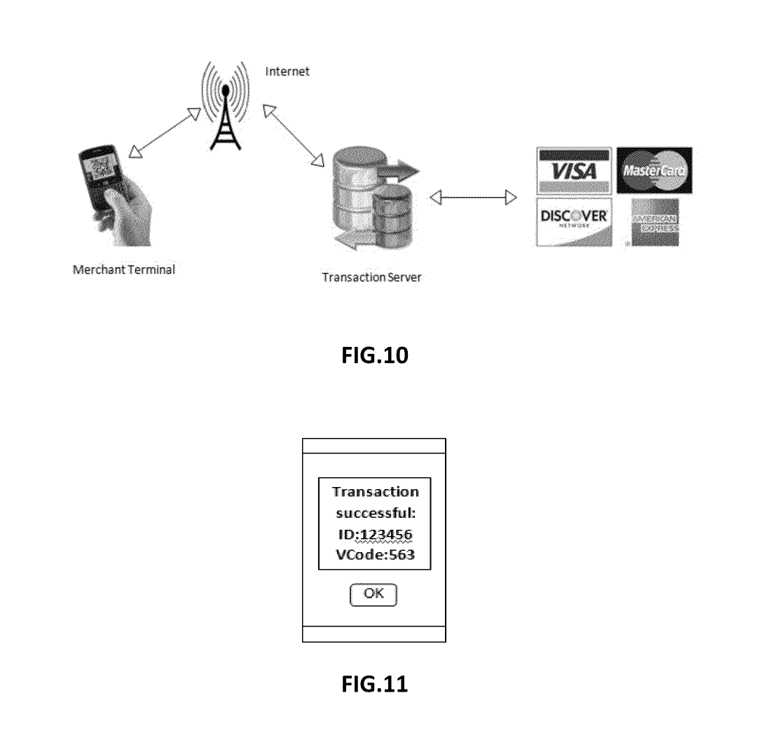

The application residing on the merchant device is also downloadable if it is mobile phone or preinstalled in case of POS terminal depending on as the case may be. If both the consumer and the merchant use mobile phones for doing the transaction, following scenario describes the transaction.
At the time of a payment using this platform, the user informs the merchant on his willingness to pay using the mobile phone. Upon which the merchant readies his mobile device.
The user logs on to his client application running on his mobile phone. Upon log on, the user selects the card to make the payment and fill the amount followed by any required PIN as may be required by the card issuer. The user can also include extra payment details like TIP for services, if he wishes to. After that the user initiates the payment by pressing a button on the phone to confirm the payment. FIG. 6,7
Upon pressing the confirmation button, the application takes the payment parameters and encrypts the data using the encryption keys sent to the application at the time of installation. FIG. 8
Additionally, the application also generates a random payment verification code and a random payment authorization code. FIG. 8
The two codes, namely, payment verification code (PVC) and payment authorization code (PAC) are also embedded in the encrypted data.
On pressing a key or a menu item of the application on the phone, these two separate codes are also displayed on the screen of the consumer along with a barcode of the encrypted data. Additionally, if the phone is NFC capable, then the application prepares the NFC communication stack.
Ideally the consumer should not show the PVC and PAC to the merchant or any one till the transaction completes.
The time stamp of the authorization data generated is also embedded into the encrypted data.
The encrypted data is then ready for transfer to the merchant's device. There are multiple mechanisms of transfer of the consumer's payment data.
The payment communications have been proposed in known art using various networking means like using NFC, Bluetooth, SMS, and Wi-Fi etc. While the communication to the merchant's device can happen across the above said means, they all have shortcomings. For example, NFC capability may not be available on all mobile phones. While Bluetooth is available in most mobiles, but it requires pairing of devices before any data transfer can happen which makes it cumbersome, more so in a crowded place like a fast food counter pairing will be very difficult. Using SMS is not reliable for guaranteed delivery so it should not be used for payment authorizations. Similarly Wi-Fi may not be available and even if available, will also make the mobile phones vulnerable to hacking as the network will be open to public or using it become too impractical.
Therefore an embodiment of the invention proposes that the mobile screen or the mobile's audio visual interfaces should be used for the communication of the consumer's payment authorization. However if NFC is available for both the user as well as the merchant then it can also be used
In one embodiment, the encrypted data of the consumer's payment authorization is converted to a Visual Code in the form of a2D Barcode, or a Color Code or could be Visual Symbols detectable by appropriate Optical Code readers and displayed in the screen of the mobile of the consumer.
In another embodiment, the encrypted data of the consumer's payment authorization can also be sent across the NFC medium, if the merchant can accept such a medium of communication. FIG. 9
The consumer then hands over the mobile to the merchant similarly as he would hand over his card to the merchant.
The merchant then scans either using the camera of the mobile phone or a standalone scanner or camera in case of a POS terminal, the visual code using the camera, or through NFC and receives the encrypted data into his client application. FIG. 9
The client application residing on the merchant's mobile, adds relevant merchant details, merchant time stamp etc. and creates the data to be sent for authorization.
At this point, the merchant can also see on his screen, the amount authorized by the consumer, just to make sure that the amount is right according to what he wishes to charge for the goods or services.
The merchant then, sends the data for authorization using the network he is connected to, as explained before. FIG. 10
The data received by the authorization server decrypts the data, using the consumer's ID and the consumer's encryption keys pairs stored at the server. The server application then extracts the card details from the decrypted data and passes the details to the payment gateway for approval. It should be made clear that at no point the authorization server, stores the card details in its persistent storage systems e.g. in data logs etc. It is kept in the volatile memory of the authorization server only for the purpose of processing momentarily and is cleared once it is completed. Doing to will ensure that no card details can be stolen from the server as explained before.
The payment gateway is the same network used to authorize normal credit, debit cards etc.
Upon receiving the approval code from the payment gateway, if everything is ok, as in, the payment is approved; the authorization server appends the approval code with the payment verification code sent by the consumer's data and sends it back to the merchant.
Upon receiving of the approval code, the verification code is made visible on the merchant's screen for the consumer to verify. FIG. 11
If the verification code in the merchants screen is same as is in the consumer's screen, then the consumer feeds in the payment authorization code into the merchant's keypad.
At this point the consumer is assured of the fact that transaction was safe and there was no fraud committed on his card details.
The merchant's client application sends back the payment authorization code back to the authorization server.
At the server, if the payment authorization code received matches the earlier code sent along with the encrypted data, then the transaction is marked safe and authenticated and the server sends back the final approval of the transaction.
At this point the merchant is sure of the transaction being completed and he hands over the goods to the consumer.
In case at the authorization server the code does not match or it is not received in time limited duration, then the transaction done for the merchant for this session is reversed as a fraudulent transaction and the information is sent back to the merchant. The above description actively prevents fraudulent transaction of multiple natures as explained below.
Suppose the consumer hands over the data in the form of the visual data, and it is received by the merchant and a malicious program in the merchant's mobile phone intercepts the data which instead of performing the transaction just reports an error effectively not performing the transaction.
The user sees the error screen and just ignores the payment.
The person committing this fraud at the merchant's end wishes to use the recorded information to do fraudulent transactions later when the consumer has left the merchant premises.
However the invention prevents this from happening on multiple ways.
First, if the time stamp of the transaction authorization in the encrypted data from the consumer's data does not maintain the maximum boundary of the time of actual transaction made by the merchant (which he does later) then the transaction is voided automatically.
In case the transaction is done within the time frame, then also the merchant will need the payment authorization code to complete the transaction. Since this code is not shared by the consumer the transaction can never complete.
In another case, if the merchant uses a fraudulent application on his phone similar to phishing frauds and show the consumer that he has transacted the payment without actually doing it, then also the merchant needs the payment verification code in the approval code as explained above. Since this code is decrypted by the server, it can never be known to the merchant, and his falsely generated code will not match that of the code available with the consumer. The consumer can easily deny the authorization on such a situation as he now recognizes the possible fraudulent transaction.
In another case, if the consumer loses his mobile, yet his mobile cannot be used for committing fraudulent transactions because all data is encrypted before storing in the non-volatile memory of the consumer's TPD using keys which can only be decrypted by the server.
Also In such cases, without the right password, access to the client application is not available with a limited number of tries to password tries; say 3 attempts; after which the application deletes all data and becomes useless and needs re-registration again.

In another embodiment, the data transfer from consumer's TPD to merchant mobile can also happen by using the speaker of the consumer's TPD and the microphone of the merchant's mobile phone either directly placing the mobile phones close together or by using a properly modified hands-free connection. Rest of the data process remains same.

In another embodiment, the transaction of online systems can also be secured using this, by presenting the consumer's mobile phone screen in front of the webcam and the image thus captured is sent to the merchant to do the transaction in a similar manner as explained above.

The encryption in the system is asymmetric encryption. Under this system, only the public key of the encryption is shared with the client applications. This is important because, if there is any eavesdropping in the network to read the encrypted data or the key is extracted from the installed application of the mobile phone by hacking it, then also there is no chance of decrypting of the data by a hacker as the private key is available only at the server.

Also the card data that is stored in the client device is encrypted using this public key so that in case if anyone copies the data to decrypt the card data, he cannot do so as the private key is not available.

It will thus be seen that the objects set forth above, among those made apparent from the preceding description, are efficiently attained and, since certain changes may be made in carrying out the above method and steps set forth without departing from the spirit and scope of the invention is intended that all matter contained in the above description and shown in the accompanying drawings shall be interpreted as illustrated and not in a limiting sense.

It is also to be understood that the following claims are intended to cover all of the generic and specific features of the invention herein described and all statements of the scope of the invention in which, as a matter of language might be said to fall there between.

I claim:

1. A secure payment system using trusted personal device comprising of:
a) an application based platform installed on trusted personal devices of user (payer) and merchant (payee);
b) a system on the said application to store data;
c) an encrypted code generation system;
d) an encrypted code reader system;
e) a decrypting system;
f) multistep authentication system;
g) a payment verification system;
wherein:
the said application is capable of storing the data, generating encrypted code, and authenticating transaction;
the decrypting is done by a secured sever at point of transaction.

2. The secure payment system as claimed in claim 1 wherein the trusted personal device is selected from the group of mobile phone, smart phone, iPod, MP3, iPad, palmtop, and alike.

3. The secured payment system as claimed in claim 1 wherein the said encrypted code is in the form of binary text, a barcode, 2D barcode, audio-signal or image.

4. The secured payment system as claimed in claims 1 & 3 wherein the said encrypted code is achieved through asymmetric encryption.

5. The secured payment system as claimed in claim 1 wherein the said multistep authentication system includes generating passwords, public keys, private keys, authentication codes, verification keys, PINs, IPINs, and alike.

6. The secured payment system as claimed in claim 1 wherein the point of transaction includes the authorizing institutions like banks, transaction authentication service providers.

7. A method of making a secure payment using trusted personal device comprising the steps of:
(I) initializing the secure payment system by:
a. installing an application based platform on the trusted personal devices of user and merchant and on the servers at points of transaction;
b. storing the personal credit and/or debit card details on the application on user's device;
wherein:
once the application is installed, unique public keys and corresponding unique private keys are generated each for user and merchant using the system;
one time registration of public key at point of transaction is required by the user as well as merchant to use the system;
the card details stored on the said application on user's device include data like card number, validity details, PIN/IPIN/Password and are protected through access code set by the user himself to prevent misuse;
(II) making transaction using the system initiated in step (I) by following the steps of:
a. putting the transaction details on the device by user;
b. generating encrypted code and a random authentication code by the user's device wherein the authentication code is visible to user and is also encrypted in the encrypted code;
c. receiving of the encrypted code of step b by merchant's device;
d. sending the encrypted code received in step c along with merchant's public key to the server at point of transaction;
e. decrypting of the code received by server in step d;
f. verification of the decrypted details by server;
g. authorizing transaction upon successful verification by the server;
h. receiving transaction confirmation along with the random authentication code by the merchant's device;
i. verification of authenticity of transaction by user by matching the random authentication code generated in step b with that received in step h.

8. The method of making a secure payment as claimed in claim 7 wherein:
a. during the transaction, merchant needs to be connected to the server at point of transaction through any of the connection means but not limited to GSM, SMS, MMS, GPRS, EDGE, 3G, Wi-Fi, Bluetooth, chip card based or Near Field Communication (NFC);
b. the application on the user's device verifies and validates PIN/IPIN every time user transacts using the said system;
c. the unique public key can be modified, edited or changed and reregistered by the user and merchant;
d. the encrypted data is achieved through asymmetric encryption method;
e. the encrypted data generated by user's device contains the public key, card details, PIN/IPIN/Password and random authentication code;
f. the encrypted data is valid for a limited period of time;
g. new encrypted data with new random authentication code is generating each time the user transacts using the said system;
h. the server verifies the details by matching account details and other user details like PIN of user and merchant, and on successful verification authorizes transaction to merchant's account from the user account.

9. A secure payment system using trusted personal device and method thereof as substantially as described herein with reference to the drawings and the foregoing description.
